(19) United States
(12) Patent Application Publication
(10) Pub. No.: US 2026/0208118 A1
(43) Pub. Date: Jul. 23, 2026

(54) COMPOSITIONS FOR PREPARING MEMBRANES FROM POLYMER SOLUTIONS

(71) Applicant: The Lubrizol Corporation, Wickliffe, OH (US)

(72) Inventors: Alexander V. Lubnin, Copley, OH (US); Kurt Schroeder, North Royalton, OH (US); Dylan Michael Kosienski, Broadview Heights, OH (US)

(73) Assignee: The Lubrizol Corporation, Wickliffe, OH (US)

(21) Appl. No.: 19/138,885

(22) PCT Filed: Dec. 8, 2023
(86) PCT No.: PCT/US2023/083098

§ 371 Date: Jun. 13, 2025

Related U.S. Application Data
(60) Provisional application No. 63/432,492, filed on Dec. 14, 2022.

(51) Int. Cl. B01D 67/00; B01D 69/02; B01D 71/30; C08J 9/28

(52) U.S. Cl. CPC B01D 67/0011; B01D 67/0013; B01D 69/02; B01D 71/301; C08J 9/283; B01D 2323/219; B01D 2325/026; C08J 2201/0544; C08J 2327/24

(57) ABSTRACT

The disclosed technology relates to polymeric porous membrane prepared from a casting solution of the polymer in a solvent having a good environmental and toxicological profile.

### BACKGROUND OF THE INVENTION

The disclosed technology relates to polymeric membrane prepared from a casting solution of the polymer in a solvent having a good environmental and toxicological profile.

Membrane technology has become an important technology for the separation and purification of numerous compounds and mixtures. Traditionally, one of the more preferred membrane formation processes is Non-Solvent Induced Phase Separation (NIPS). Alternatively, Vapor Phase Induced Phase Separation (VIPS) and Thermally Induced Phase Separation (TIPS) methodologies have been used to form membranes. Most large-scale membrane manufacturing involves the NIPS process. NIPS has been widely studied, and numerous papers have been published describing the complex thermodynamic and kinetic aspects of the non-solvent phase inversion process. The NIPS process minimally involves dissolving the membrane resin in a solvent, casting the dissolved polymer onto a substrate, and precipitating the casted article in a non-solvent bath. The membrane morphology is determined in a matter of seconds once the casted polymer solution contacts the non-solvent. The morphology of the resulting membrane plays a critical role in the overall performance of the membrane. The size and distribution of pore sizes is a determining factor in the flux of the feed solution and retention of solutes in the case of membranes designed for protein separations.

The morphology of the membrane can take on various forms. Often, a thin skin layer forms at the very surface of the membrane that is on the order of a few hundred nanometers in thickness. Beneath the skin layer a complex array of morphologies can exist including a sponge-like morphology, long finger-like channels, and large macro-voids. Reproducing these types of morphologies can be difficult, and the presence of macro-voids is largely considered undesirable as these cavities in the membrane can distort and collapse the membrane under the operating membrane pressures. An alternative morphology, which can result from the NIPS process, is a complete sponge-like structure. In such a case, the complete structure of the membrane is free of long finger-like channels and micro-voids and may still have a dense skin layer at the surface of the membrane. It is believed that this more uniform pore morphology is preferred as it provides for more robust mechanical integrity of the membrane under high operating pressure conditions.

Additives and process variables affect the desired membrane morphology. The selection of the membrane solvent is also critical because it affects the membrane morphology and performance. Traditionally, solvents capable of dissolving the membrane resins have poor ecological and toxicological profiles. Solvents, such as dimethyl formamide (DMF), dimethyl acetamide (DMAC), N-methyl pyrrolidone (NMP), and the like, risk operator exposure to potentially harmful chemicals and are often released into water streams when the quenching solutions are disposed of. Numerous environmentally preferred solvents for membrane manufacturing have been disclosed in the literature and are often referred to as “green” solvents. Examples of “green” solvents include: dihydrolevoglucosenone, dimethyl-2-methyl glutarate, 4-hydroxymethyl-2-isobutyl-2-methyl-1,3-dioxolane, methyl-5-dimethylamino-2-methyl-5-oxopentanoate, and N-butyl pyrrolidone. These relatively poor solvents for the membrane resin either do not dissolve the resin or require very dilute concentrations of resin which severely limits the commercial viability for membrane manufacturing.

Thus, there is a need for solvents that are amenable to the NIPS process using water as the non-solvent and that have improved toxicological and environmental profiles compared to the common solvents, such as NMP, DMF, and DMAC, and that can readily dissolve membrane polymers, such as chlorinated poly(vinyl chloride) resin (CPVC), either alone or in combination with other solvents, at viscosities suitable for casting such polymers onto supports.

### SUMMARY OF THE INVENTION

In one embodiment, the disclosed technology solves the foregoing problems by employing substituted amide solvents where substitutes include alkoxy, ester and amide substituents.

The disclosed technology provides a method for manufacturing a polymer, which includes dissolving the polymer in a solvent, casting the resulting solution onto a substrate, and precipitating the cast polymer solution in a non-solvent bath, such as water. The solvent in the method is an amide represented by the Formula I:

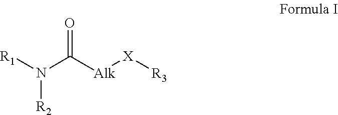

where:
   X is one of O, —CO₂—, or —C(═O)N(R₄)—;
   R1, R2, R3, and R₄ are independently H, or CₙH₍₂ₙ₊₁₎;
   Alk is a CₙH₂ₙ alkylene group, linear or branched; and
   n is an integer from 1 to 10.

The solvent can also be that of Formula II:

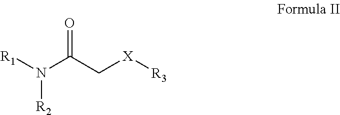

where:
   X is one of 0, —CO₂—, or —C(═O)N(R₄)—;
   R1, R2, R3, and R₄ are independently H, or CₙH₍₂ₙ₊₁₎; and
   n is an integer from 1 to 10.

The solvent can also be that of Formula III:

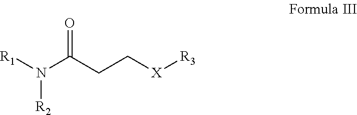

where:
   X is one of O, —CO₂—, or —C(═O)N(R₄)—;
   R1, R2, R3, and R₄ are independently H, or CₙH₍₂ₙ₊₁₎; and
   n is an integer from 1 to 10.

In some embodiments, the solvent in the method can include either or both of the amide solvent of Formula I and/or Formula II and/or Formula III, and some volume of another solvent, such as, for example, methyl 5-(dimethylamino)-5-oxopentanoate or methyl 5-(dimethylamino)-2-methyl-5-oxopentanoate.

There is also provided a casting solution for preparing a porous membrane that includes 10 to 30 wt. % polymer resin based on the weight of the casting solution, and the solvents of Formula I, Formula II, Formula III or mixtures thereof.

The polymer resin in the method and casting solution can be, for example, a halogenated polymer, such as, for example, poly(vinylidene fluoride) PVDF, poly(vinyl chloride) PVC, CPVC. The polymer can also be any of the numerous other membrane polymers available, such as, for example, thermoplastic urethane (TPU), polystyrene, polyether sulfone, regenerated cellulose, polysulfone, polyamide, and polyacrylonitrile.

The technology also includes a porous membrane cast from the casting solution as described above.

### DETAILED DESCRIPTION OF THE INVENTION

Various preferred features and embodiments will be described below by way of non-limiting illustration.

The technology is directed to separation or purification membranes prepared with a mild amide solvent. The terms “mild amide solvent” or “mild solvent” as used herein are used to mean solvents that have a good toxicological and environmental profile compared to common solvents, such as, for example, N-methyl-pyrrolidone (NMP), dimethylformamide (DMF), and dimethylacetamide (DMAC). By “good toxicological and environmental profile” it is meant that the mild solvent herein have a more favorable human health and environmental profile, and for example, would not be labeled as a hazard per Hazard Classification and Labelling (CLP) or Globally Harmonized Systems (GHS) of Safety Data Sheets (SDS) and labelling, including non-carcinogenic/mutagenic/reproductive toxins, more favorable material handling, and overall less regulatory burdens on use.

Preparation of a membrane for separation or purification using mild amide solvent can be accomplished by dissolving a target polymer resin therein to prepare a casting solution. Dissolution of polymer resin can be accomplished with the aid of heat.

The mild solvents are amides represented by Formula I:

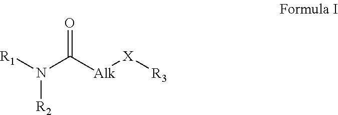

where:
   X is one of O, —CO₂—, or —C(═O)N(R₄)—;
   R1, R2, R3, and R₄ are independently H, or CₙH₍₂ₙ₊₁₎;
   Alk is a CₙH₂ₙ alkylene group, linear or branched; and
   n is an integer from 1 to 10.

In some embodiments, X is O and R3 is CₙH₍₂ₙ₊₁₎.

In other embodiment, the alkylene group of Formula I can contain only one or two carbon atoms, in which case the mild solvents can be represented, respectively, by Formula II or Formula III:

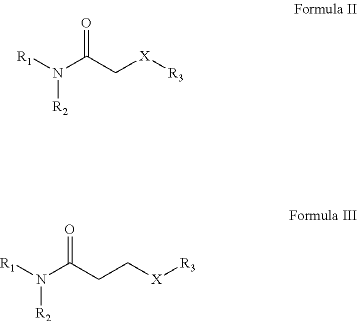

where X, R1, R2, R3, R₄ and n are as defined above.

In some instances of either Formula I, Formula II or Formula III, X can be —CO₂—. However, in embodiments, the X group is not an ester, in which case X in Formula I or Formula II or Formula III can only be one of O, or —C(═O)N(R₄)—.

In some instances of either Formula I or Formula II or Formula III, X can be C(═O)N(R₄)—. However, in embodiments, the X group is not an amide, in which case X in Formula I or Formula II or Formula III can only be one of O, or —CO₂—.

Example mild solvents include 3-methoxy-N,N-dimethylpropanamide and 3-butoxy-N,N-dimethylpropanamide.

Casting the membrane from the casting solution can be prepared using only mild amide solvent, or mixtures of other solvents in combination with mild amide solvent. Other solvents are not particularly limited provided the resin dissolves completely.

Suitable alternative solvents include: dimethyltryptamine (DMT), DMAC, dimethyl sulfoxide (DMSO), sulfolane, glycol ethers, and “green” solvents. Other alternative solvents can include, for example, N-methyl pyrrolidone (NMP), N-ethyl pyrrolidone (NEP), N-butyl pyrrolidone, dimethyl formamide (DMF), methyl ethyl ketone (MEK), methyl isobutyl ketone (MIBK), cyclohexanone, tetrahydrofuran (THF), and acetone. Some polar protic solvents may be employed as well, such as, for example, methanol, ethanol, isopropyl alcohol (IPA).

The solvent for the blend can be a mixture of these solvents with the mild solvent, and may also include one or more other liquids that are non-solvents for the target polymer resin. The polymers can be mixed with portions of the solvent separately and then mixed, they can be mixed with the solvent sequentially, or the polymers can be mixed with the solvent simultaneously. It may be desirable to heat the solvent-polymer mixture while mixing or agitating to facilitate complete dissolution of the polymers. The solvent may be present in the casting solution at a concentration of from about 30 to about 90 wt %, or from about 30 to about 70 wt %, or even from about 35 to about 65 wt % or about 40 to about 60 wt %.

The casting solution provided herein contains polymer resin. The polymer resin can be, for example, a halogenated polymer, such as a polymer of vinyl chloride or vinyl fluoride and various other fluoropolymers, such as poly(vinylidene fluoride). The polymer resin can also be a thermoplastic polyurethane polymer. Polyethersulfone, regenerated cellulose, polysulfone, polyamide, polystyrene and polyacrylonitrile are other polymer resins that may be employed in casting solution to prepare a membrane.

Polymers of vinyl chloride include, for example, poly(vinyl chloride) (PVC) or chlorinated poly(vinyl chloride) (CPVC), which may collectively be referred to herein as “(C)PVC.”

PVC and CPVC resins are both known to the art and to the literature and are commercially available. CPVC can be prepared by chlorinating PVC resin and there are considerations pertaining to the PVC, whether it being used in the casting solution itself, and ultimately the flat sheet porous membrane itself, or as a precursor from which a CPVC product may be derived for use in the casting solution/flat sheet porous membrane. The molecular weight of PVC suitable for the casting solution/membrane, as indicated by inherent viscosity (I.V.) measurement per ASTM D1243, should generally range from about 0.4 to about 1.4 at the extremes. All reference to molecular weight in this specification will mean “number average molecular weight,” unless specified otherwise. Desirably, the I. V. of the PVC employed (itself, or as precursor to the CPVC) falls within a range of from about 0.6 to about 1.4, or from about 0.5 to 1.3, or even from about 0.54 to 1.2, or about 0.6 to 1.1, and in some embodiments from about 0.65 to 0.90 or 0.92, or even from about 0.65 to 1.

(C)PVC resin suitable for the casting solution/membrane can have a chlorine content of from about 56 to about 72 wt % based on the weight of the polymer, or from about 58 to about 71 wt %, or about 59 to about 70 wt %. In terms of the various resins, PVC resin suitable for the casting solution/membrane can have a chlorine content of about 57 to about 58 weight percent (wt %), such as from about 56 to about 59 wt %. CPVC resin suitable for the casting solution/membrane can include CPVC having a chlorine content of from about 59 to about 72 wt %, or from about 60 to about 70 or 71 wt %, and even from about 63 to about 68 or 69 wt %, or between about 64 or 65 and 67 wt %.

The casting solution can contain (C)PVC (i.e., either PVC or CPVC or a combination thereof) at a concentration of from about 10 to about 40 wt %, or for example, about 15 to 30 wt %, or even from about 18 to 25 wt % based on the total weight of the casting solution.

Other polymers can be included in the casting solution along with the (C)PVC. When included, these other polymers may be included in the casting solution at a concentration of from about 0.1 to about 15 wt % of the casting solution. The other polymers may also be included in the casting solution at a concentration of from about 0.5 to about 12 wt %, or 1 to 10 wt %.

It is well understood by those skilled in the art that “polyurethane” is a generic term used to describe polymers obtained by reacting isocyanates with at least one hydroxyl-containing compound, amine-containing compound, or mixture thereof. It also is well understood by those skilled in the art that polyurethanes can also include allophanate, biuret, carbodiimide, oxazolidinyl, isocyanurate, uretdione, and other linkages in addition to urethane and urea linkages.

The TPUs suitable for the casting solution/membrane will include at least one polyisocyanate. Polyisocyanates have an average of about two or more isocyanate groups, preferably an average of about two to about four isocyanate groups and include aliphatic, cycloaliphatic, araliphatic, and aromatic polyisocyanates, used alone or in mixtures of two or more. Diisocyanates are more preferred.

Specific examples of suitable aliphatic polyisocyanates include alpha, omega-alkylene diisocyanates having from 5 to 20 carbon atoms, such as pentamethylene-diisocyanate, hexamethylene-1,6-diisocyanate, 1,12-dodecane diisocyanate, 2,2,4-tri-methyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include pentamethylene diisocyanate, hexamethylene-1,6-diisocyanate, 2,2,4-trimethyl-hexamethylene-diisocyanate, and 2,4,4-trimethyl-hexamethylene diisocyanate.

Specific examples of suitable cycloaliphatic polyisocyanates include dicyclohexylmethane diisocyanate, (commercially available as Desmodur™ W from Bayer Corporation), isophorone diisocyanate, 1,4-cyclohexane diisocyanate, 1,3-bis-(isocyanatomethyl)cyclohexane, and the like. Preferred cycloaliphatic polyisocyanates include dicyclohexylmethane diisocyanate and isophorone diisocyanate.

Specific examples of suitable araliphatic polyisocyanates include m-tetramethyl xylylene diisocyanate, p-tetramethyl xylylene diisocyanate, 1,4-xylylene diisocyanate, 1,3-xylylene diisocyanate, and the like. A preferred araliphatic polyisocyanate is tetramethyl xylylene diisocyanate.

Examples of suitable aromatic polyisocyanates include 4,4′-diphenylmethylene diisocyanate, toluene diisocyanate, their isomers, naphthalene diisocyanate, and the like. A preferred aromatic polyisocyanate is 4,4′-diphenylmethylene diisocyanate and toluene diisocyanate.

The TPUs suitable for the casting solution/membrane can also include at least one active hydrogen-containing compound. The term “active hydrogen-containing” refers to compounds that are a source of active hydrogen and that can react with isocyanate groups via the following reaction: —NCO+H—X→—NH—C(═O)—X.

Examples of suitable active hydrogen-containing compounds include but are not limited to polyols, poythiols and polyamines.

The term “polyol” denotes any high (i.e., between 500 and 10,000 g/mol) number average molecular weight product having an average of about two or more hydroxyl groups per molecule. Examples of such polyols include higher polymeric polyols such as polyester polyols and polyether polyols, as well as polyhydroxy polyester amides, hydroxyl-containing polycaprolactones, hydroxyl-containing acrylic in-terpolymers, hydroxyl-containing epoxides, polyhydroxy polycarbonates, polyhydroxy polyacetals, polyhydroxy polythioethers, polysiloxane polyols, ethoxylated polysiloxane polyols, polybutadiene polyols and hydrogenated polybutadiene polyols, polyacrylate polyols, halogenated polyesters and polyethers, and the like, and mixtures thereof. The polyester polyols, polyether polyols, polycarbonate polyols, polysiloxane polyols, and ethoxylated polysiloxane polyols are preferred.

A preferred polyester polyol is a diol. Preferred polyester diols include poly(butanediol adipate); hexane diol, adipic acid and isophthalic acid polyesters such as hexane adipate isophthalate polyester; hexane diol neopentyl glycol adipic acid polyester diols, as well as propylene glycol maleic anhydride adipic acid polyester diols, and hexane diol neopentyl glycol fumaric acid polyester diols.

Polyether diols may be substituted in whole or in part for the polyester diols. Preferred polyethers include poly(propylene glycol), polytetrahydrofuran, and copolymers of ethylene oxide and propylene oxide.

Polycarbonates include those obtained from the reaction of (A) diols such 1,3-propanediol, 1,4-butanediol, 1,6-hexanediol, diethylene glycol, triethylene glycol, tetraethylene glycol, and the like, and mixtures thereof with (B) diarylcarbonates such as diphenylcarbonate or phosgene.

Polyacetals include the compounds that can be prepared from the reaction of (A) aldehydes, such as formaldehyde and the like, and (B) glycols such as diethylene glycol, triethylene glycol, ethoxylated 4,4′-dihydroxy-diphenyldimethylmethane, 1,6-hexanediol, and the like. Polyacetals can also be prepared by the polymerization of cyclic acetals.

Instead of a long-chain polyol, a long-chain amine may also be used to prepare the TPU. Suitable long-chain amines include polyester amides and polyamides, such as the predominantly linear condensates obtained from reaction of (A) polybasic saturated and unsaturated carboxylic acids or their anyhydrides, and (B) polyvalent saturated or unsaturated aminoalcohols, diamines, polyamines, and the like, and mixtures thereof.

Diamines and polyamines are among the preferred compounds useful in preparing the aforesaid polyester amides and polyamides. Suitable diamines and polyamines include 1,2-diaminoethane, 1,6-diaminohexane, 2-methyl-1,5-pentanediamine, 2,2,4-trimethyl-1,6-hexanediamine, 1,12-diaminododecane, 2-aminoethanol, 2-[(2-aminoethyl)amino]-ethanol, 1-amino-3-aminomethyl-3,5,5-trimethylcyclohexane (isophorone diamine or IPDA), bis-(4-aminocyclohexyl)-methane, bis-(4-amino-3-methyl-cyclohexyl)-methane, 1,4-diaminocyclohexane, 1,2-propylenediamine, hydra-zine, polyoxypropylene amines, and the like, and mixtures thereof. Preferred diamines include 1-amino-3-aminomethyl-3,5,5-trimethyl-cyclohexane (isophorone diamine or IPDA), bis-(4-aminocyclohexyl)-methane, bis-(4-amino-3-methylcyclohexyl)-methane, ethylene diamine, and mixtures thereof. Other suitable polyamines include Jeffamine® D-2000 and D-4000, which are amine-terminated polypropylene glycols, differing only by molecular weight, and which are available from Huntsman Chemical Company.

The TPU may include side-chains prepared, for example, from alkylene oxides. As used herein, the term “alkylene oxide” includes both alkylene oxides and substituted alkylene oxides having 2 to 10 carbon atoms. The active hydrogen-containing compounds can have poly(alkylene oxide) side chains sufficient in amount to comprise about 12 wt. % to about 80 wt. %, preferably about 15 wt. % to about 60 wt. %, and more preferably about 20 wt. % to about 50 wt. %, of poly(alkylene oxide) units in the TPU on a dry weight basis. At least about 50 wt. %, preferably at least about 70 wt. %, and more preferably at least about 90 wt. % of the poly(alkylene oxide) side-chain units comprise poly(ethylene oxide), and the remainder of the side-chain poly(alkylene oxide) units can comprise alkylene oxide and substituted alkylene oxide units having from 3 to about 10 carbon atoms, such as propylene oxide, tetramethylene oxide, butylene oxides, epichlorohydrin, epibromohydrin, allyl glycidyl ether, styrene oxide, and the like, and mixtures thereof.

The casting solution provided herein can also contain pore forming agent, although a pore forming agent may be absent. A pore-forming agent is a substance that is soluble in the blend solvent (described below) and that may or may not be soluble in the coagulation solvent (described below). The presence of a pore-forming agent can provide for greater control over the size and distribution of pores in the porous flat sheet membrane that is formed from the coagulation in the coagulation bath. The pore-forming agent in its pure state at room temperature can be a liquid, but is often a water-soluble solid. Examples of pore-forming agents suitable for the casting solution/membrane include salts and phenols. For example, salts of alkali metals, alkaline earth metals, transition metals or ammonium in the form of halides or carbonates can be used as pore-forming agents. Specific examples include ammonium chloride, calcium chloride, magnesium chloride, lithium chloride, sodium chloride, zinc chloride, calcium carbonate, magnesium carbonate, sodium carbonate, and sodium bicarbonate. Sodium citrate can also be used as a pore forming agent. Examples of phenols include phenol, ethylphenol, catechol, resorcinol, hydroquinone and methoxyphenol. Other conventional pore-forming agents include non-solvent liquids and also include polymers such as poly(vinyl alcohol), poly(vinyl pyrrolidone), glycols, such as polyethylene glycol, ethyleneoxide copolymers, and hydroxyalkylcellulose polymers.

The molecular weight of the pore forming agent, in some embodiments, can have an effect on the size of the pores formed in the flat sheet porous membrane. Normally the pore size of membranes increases with increasing molecular weight of the pore former, but this is not always a hard rule on this. Some-times, pore size/pore distribution reaches an optimum value and it does not increase with an increase in pore former molecular weight. The effect of molecular weight varies from pore former to pore former.

In an embodiment, the pore forming agent can be a poly(vinyl pyrrolidone) having a molecular weight of from about 8000 to about 150,000. In certain instances, such as for preparing a microfiltration or ultrafiltration membrane, the pore former may be a poly(vinyl pyrrolidone) having a molecular weight of from about 40,000 to about 150,000. In other instances, such as for preparing a nanofiltration membrane, the poly(vinyl pyrrolidone) pore forming agent may have a molecular weight of from about 200 to about 40,000 g/mol.

In an embodiment, the pore forming agent can be a poly(ethylene glycol)-block-poly(propylene glycol)-block-poly(ethylene glycol) copolymer having a molecular weight of from about 1000 to about 6000 g/mol. In certain instances, such as for preparing a microfiltration membrane, the pore former may be a poly(ethylene glycol)-block-poly(propylene glycol)-block-poly(ethylene glycol) copolymer having a molecular weight of from about 3000 to about 6000 g/mol. In other instances, such as for preparing an ultrafiltration membrane, the poly(ethylene glycol)-block-poly(propylene glycol)-block-poly(ethylene glycol) copolymer pore forming agent may have a molecular weight of from about 2000 to about 4000 g/mol. In other instances, such as for preparing a nanofiltration membrane, the poly(ethylene glycol)-block-poly(propylene glycol)-block-poly (ethylene glycol) copolymer pore forming agent may have a molecular weight of from about 1000 to about 2000 g/mol.

In an embodiment, the pore forming agent can be a polyethylene glycol having a number average molecular weight of from about 200 to about 20,000 g/mol. In certain instances, such as for preparing a microfiltration membrane, the pore former may be a polyethylene glycol having a number average molecular weight of from about 8000 to about 20,000 g/mol. In other instances, such as for preparing an ultrafiltration or nanofiltration membrane, the polyethylene glycol pore forming agent may have a molecular weight of from about 200 to about 10,000 g/mol.

As mentioned, the pore forming agent may be absent. The pore forming agent can also be present in the casting solution at a concentration of from about 0.1 to about 20 wt %, or from about 0.2 to about 18 wt %, or from about 0.4 to about 16 wt %, or even from about 0.5 to about 15 wt % or about 0.5 to about 10 wt %. In some instances the pore forming agent may be present in the casting solution at a concentration of from about 0.1 to about 5 wt %, or from about 0.2 to about 2.5 wt %, or even from about 0.25 to about 1 wt %.

The casting solution can also include processing aids, such as surfactants, drying agents, co-solvents, such as polar aprotic solvents, or any combination thereof. Among other things, processing aids can be employed to modify surface properties, such as hydrophobicity, or further increase performance, such as compressibility and tensile strength, of a flat sheet porous membrane prepared from the casting solution, for example, to improve fouling resistance. When present, the processing aids, collectively, can be in the casting solution at a concentration of about 0.1 to about 10 wt. %, or from about 0.5 to about 8 wt %, or even from about 1 to about 6 wt %.

Exemplary processing aids include phosphoramides, dialkyl sulfoxides, metal chelate additives containing a bidentate ligand and a metal atom or metal ion, e.g., acetylacetonate (acac) or fluorinated acetylacetonate, beta-diketonates or fluorinated beta-diketonates, zeolites, fullerenes, carbon nanotubes, and inorganic mineral compounds.

The surfactant(s) can be selected from among nonionic, cationic, anionic, and zwitterionic surfactants depending on the chemistry of the other additives. For example, a cationic surfactant would not be selected when anionic additives are being used. When present, the amount of surfactant can be from about 0.005 wt % to about 0.5 wt %, or from about 0.01 wt % to about 0.25 wt %, or from about 0.05% to about 0.25%.

In some embodiments, one or more drying agents can be included in the casting solution. Membranes are often dried at either ambient or elevated temperatures to maintain performance during storage and transportation. Storage and shipping of membranes in a wet state presents challenges as residual water in the pores of membranes provides an opportunity for microbes to flourish. Furthermore, the pore size and morphology of membranes stored at or below the freezing temperature of water can be damaged. Drying agents can have both antimicrobial effects and also allow transportation at significantly colder temperatures than in a wet state. Drying agents can include, for example, hydrophobic organic compounds, such as a hydrocarbon or an ether, glycerin, citric acid, glycols, glucose, sucrose, triethylammonium camphorsulfonate, triethylammonium benzenesulfonate, triethylammonium toluenesulfonate, triethylammonium methane sulfonate, ammonium camphor sulfonate, and ammonium benzene sulfonate, and those described in U.S. Pat. Nos. 4,855,048; 4,948,507; 4,983,291; and 5,658,460. When present, the amount of drying agent can be from about 2 wt % to about 10 wt %, or from about 3 wt % to about 5 wt %.

Preparation of the membrane also requires one or more non-solvent quenching solutions. The quenching solution can be water-based and can include various additives including, for example, alcohols (ethanol, isopropanol), humectants (glycerol and glycols), casting solution solvents and water soluble surfactants. The temperature of the quench tank can be manipulated in order to tune the morphology of the membrane. In one embodiment, the initial quench tank contains mostly water. The initial quench tank can be followed by additional water tanks in order to facilitate removal of the solvent(s) from the casted membrane. In another embodiment, the final quench tank can contain a treatment fluid that is a humectant or mixture of humectant and water. Examples include a mixture of between 15-50% by weight of a high boiling organic solvent and water. Examples of treatment fluids include water and comprise high boiling organic solvents such as glycerol, propylene glycol, ethylene glycol, and other polyhydric alcohols. The humectant often aids in drying of the membrane at elevated temperatures and facilitates storage of the membrane for subsequent use while minimizing any loss in flux or solute retention in the target application. Optionally, a preservative can be added to the final water rinse tank or treatment fluid tank if desired. Preservatives can be added to inhibit undesired biological growth in the membrane. Any of the well known preservatives can be used including, for example, sodium metabisulfite, substituted or un-substituted isothiazolines, etc.

The casting solution is employed to prepare a flat sheet porous membrane, or simply “membrane.” In the art, membranes may be in a tubular, hollow fiber, spiral wound, or flat sheet structure, however as used herein the term “membrane” is used to refer specifically to a porous flat sheet having a selectively permeable barrier or partition. Flat sheet means the membrane has a first surface and a second surface opposite to each other, wherein the first surface corresponds to an effluent side and the second surface corresponds to a filtrate side. Such membranes have a number of uses, and in particular for filtration, where permeability is based on the membrane being porous.

The porous flat sheet membrane (or simply “membrane”) may be cast from the casting solution described above to obtain a porous flat sheet membrane having pores suitable for use in microfiltration, ultrafiltration, or nano-filtration. That is to say that the porous flat sheet membrane may have pores suitable for microfiltration ranging in size from about 0.1 to about 10 μm, or about 0.5 to 1 μm; or pores suitable for ultrafiltration ranging in size from about 0.005 to 0.1 μm, or about 0.01 to 0.05 μm; or pores suitable for nano-filtration ranging in size from about 0.00005 to 0.01 μm, or about 0.0001 to 0.005 μm.

The pores in the membrane may be distributed through the membrane symmetrically, meaning the distribution of pores within the membrane are on average of about the same size and spacing, or asymmetrically. The pore structure in an asymmetric membrane exhibits a gradient where the size of the pores gradually changes from large pores at the filtrate side of the membrane to small pores at the effluent side. The smaller the pores, the more the effluent side layer appears as a “skin” layer on the effluent side of the membrane. While some asymmetric membranes may have a skin that is integral with the membrane, other asymmetric membranes have a skin that is coated onto a substrate to form the membrane. In either fashion, the asymmetric membrane may have a 0.01-5 micron layer over a more porous 100-300 micron thick layer. In some embodiments the pores in the asymmetric membrane do not grade out small enough to form a skin layer, in which case the membrane does not contain a skin layer. The membrane provided herein may have an asymmetric structure without a skin layer. The membrane may also have an asymmetric structure with a skin layer. Where the membrane includes a skin layer, the skin layer may be integral to the membrane or coated onto the membrane.

To produce the membrane, the casting solution is prepared, as described above, by dissolving the ingredients into the casting solution solvents. The casting solution can be prepared at elevated temperature, such as 50 to 60° C. to aid in quicker dissolution. After mixing the casting solution is degassed, for example, by application of a vacuum to the solution.

Once the casting solution is prepared, it is cast into a sheet on a flat and level surface. Casting is a well-known process that, briefly, involves pouring a solution on to a flat surface and using a casting bar having a set gap between the bar and the flat surface to pull the solution over the surface. The solution flows along the flat surface and is deposited into the form of a flat sheet having a thickness commensurate with the gap between the casting bar and the flat surface.

The cast sheet is then subjected to a phase inversion process. Phase inversion is a known process resulting in a controlled transformation of a polymer from a liquid solution to a solid in a quenching environment.

The term quenching environment means any environment that causes a polymer to precipitate from a dissolved state into a solidified state. The quenching of the cast sheet can occur in a single procedure or in more than one procedure.

The phase inversion process includes, for example, vapor phase precipitation, evaporation and immersion precipitation processes, in which the polymer of the membrane precipitates from a solvent solution in some manner. The specifics of each process are subject to, for example, the types and amounts of solvents employed, and the temperatures used.

In one embodiment, the cast sheet can be immersed, either immediately or after some delay, such as 1 minute to 4 hours, in a quenching environment for a sufficient period to allow phase inversion.

For example, the quenching of a cast sheet can involve simply moving the sheet into a coagulation bath of the quenching liquid. In another example, the quenching of a cast sheet can involve exposing the sheet to an atmosphere saturated with the quench liquid, followed by moving the substrate and sheet into a coagulation bath of the quenching liquid. Exposing the shaped membrane precursor to a saturated atmosphere can be accomplished, for example, via a vapor diffusion chamber containing a vapor of the quench liquid, which may be, for example, water or an organic solvent.

The method of phase inversion can contribute to the pore size created in the membrane. Often, a vapor diffusion chamber may be needed to prepare ultrafiltration and nanofiltration membranes. In general, the cast flat sheet can be subjected to a vapor diffusion chamber quenching environment for anywhere between 30 seconds to 30 minutes, such as, 45 seconds to 20 minutes, or 1 minute to 10 minutes, or 2 minutes to 8 minutes, again, depending on the solvents employed.

In embodiments, the quenching environment contains a liquid that is a non-solvent for the polymer or polymers in the sheet. The term non-solvent, when used in reference to a polymer, means a liquid that, when added to a solution of the polymer in a solvent, will cause phase separation of the solution at some concentration. The quench liquid can include, for example, water as the non-solvent, typically at between about 30 to about 90 wt % of the quench liquid. The quench liquid can also include a solvent selected from any of the same solvents discussed with respect to the doping solution, including, for example, one or more of N,N-dimethyl formamide, cyclohexanone, tetrahydrofuran, methanol, acetone, isopropyl alcohol, N,N-dimethylacetamide, and dimethyl sulfoxide.

After quenching, the prepared flat sheet porous membrane can be washed and/or dried to remove excess solvent.

The membrane may also be subject to further processing. For example, in one embodiment, the membrane may be subjected to deposition processes to deposit a thin layer of a coating on the top of the membrane. Such deposition processes are known in the art, and include, for example, chemical vapor deposition and thin film deposition.

The flat sheet porous membrane can be employed in methods of treating effluent streams by filtering the effluent through the membrane. The effluent stream can be a gas in gas stream, a gas in liquid stream, a liquid in liquid stream, or a suspended solid in liquid stream. Generally, such effluent treating methods require the membrane to withstand pressures of from 0 to 1000 psi, or 0 to 500 psi.

In an embodiment, the effluent can be municipal wastewater. In some embodiments, the effluent can be industrial wastewater. The membranes may also be employed to purify drinking water and in food and alcohol purification. The membranes may also be employed to separate oil and water or a gas from a mixture of gases. The effluent can also be a biological stream, such as blood, protein, fermentation by-products, and the like.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

Comparative Casting Solution #1 was prepared by dissolving 25% by weight chlorinated polyvinyl chloride (TEMPRITE® CPVC RESIN 674X571 supplied by the Lubrizol Corporation) in N-methyl pyrrolidone. The resulting viscosity of Comparative Casting Solution #1 was approximately 30,000 ceptapoise at 25 degrees Celsius and a shear rate to 10 1/seconds.

Inventive Casting Solution #1 was prepared by dissolving 20% by weight chlorinated polyvinyl chloride (TEMPRITE® CPVC RESIN 674X571 supplied by the Lubrizol Corporation) in 3-methoxy dimethyl propenamide. The resulting viscosity of Inventive Casting Solution #1 was approximately 30,000 cP at 25 degrees Celsius and a shear rate to 10 1/seconds.

Casting Solutions #1 and #2 were cast onto a nonwoven polyester sup-port (Revonex™ FS 002 from Mativ) at a wet coating thickness of 0.07 millimeters and quenched into an initial water quench bath set to 6 degrees celsius. The membranes resided in the initial water quench tank for 30 seconds. The quenched membrane was then placed in a water rinse tank set to 40 degrees Celsius for 60 seconds and were then stored in a wet state by treatment in a 0.9% by weight solution of sodium metabisulfite. The resulting membrane prepared from N-methyl pyrrolidone is herein designated as Comparative Membrane #1 and the membrane prepared from 3-methoxy dimethyl propenamide is herein designated as Inventive Membrane #1.

Comparative Membrane #1 and Inventive Membrane #2 were evaluated for their resulting morphologies by cross-sectioning and imaging using a scanning electron microscope. Comparative Membrane #1 resulted in a morphology having a thin, approximately 100 nm, skin layer and an underlying morphology with a finger-like structure. Inventive Membrane #2 surprisingly resulted in a morphology with a complete sponge-like morphology free of any finger or micro-voids.

A number of solvent alternatives were explored to understand if CPVC resin was soluble enough to make a casting solution and if a resulting sponge-like morphology could be achieved. Table 1 shows the relative solubilities of CPVC resin in solvents at approximately 20% solids CPVC. Table 1 demonstrates that the common, ecologically unfavorable solvents DMAC and NMP dissolve CPVC resin at 20% solids and casted membranes result in finger-like morphologies. The ecologically unfavorable solvent DMF resulted in a gelled casting solution with a viscosity that was too high to cast as a membrane. Table 1 also demonstrates that previously disclosed green solvents are not effective in dissolving CPVC resin to an appreciable extent.

TABLE 1
Solubility and Morphology of CPVC Solvent Combinations

| | Solubility at |
|---|---|
| Casting Solvent | 20% CPVC |
| Dimethyl formamide (DMF) | Gelled Solution |
| Dimethyl acetamide (DMAC) | Soluble |
| N-methyl pyrolidone | Soluble |
| N-butyl pyrolidone | partially soluble |
| 3-methoxy dimethyl propanamide (KJCMPA-100) | Soluble |
| 3-butoxy dimethyl propanamide (KJCBPA-100) | Partially soluble |
| methyl-5-dimethylamino-2-methyl-5- | Insoluble |
| oxopentanoate (PolarClean) | |
| Dipropyleneglycol dimethylether (Proglyme) | Insoluble |
| Tripropyleneglyocol Monomethylether | Insoluble |
| Dimethyl-2-Methyl Glutarate (85%) Dimethyl | Insoluble |
| adipate (5%) (Rhodiasolv IRIS) | |
| diacetone alcohol | Insoluble |
| N-formyl morpholine | Insoluble |
| Dihydrolevoglucosenone (Cyrene) | Insoluble |
| Υ-valerolactone | Insoluble |

Further solvent alternatives were explored to understand if PVC resin 5 was soluble enough to make a casting solution. Table 1-B shows the relative solubilities of PVC resin in solvents at approximately 20% solids PVC.

TABLE 1-B
Solubility and Morphology of PVC Solvent Combinations

| | Solubility at 20% |
|---|---|
| Casting Solvent | PVC |
| 3-methoxy dimethyl propenamide | Soluble |
| Methyl-5-dimethylamino-2-methyl-5-oxopenta- | Insoluble |
| noate | |
| 2-hydroxy-N,N-dimethylpropanamide | Insoluble |

Additional examples of solvent casting solutions are shown in Table 2.

Casting solutions were contacted with a deionized water quench solution and their resulting morphology was characterized according to the microscopic technique outlined by Gregory R. Guillen and coauthors, “Direct Microscopic Observation of Membrane Formation by Non-Solvent Induced Phase Separation”, Journal of Membrane Science, 431, 2013, pages 212-220.

TABLE 2

| | Inventive Casting Solution | | | | | | | | | Comparative Casting Solution | | | |
|---|---|---|---|---|---|---|---|---|---|---|---|---|---|
| Casting Solution Solvent | #1 | #2 | #3 | #4 | #5 | #6 | #7 | #8 | #9 | #1 | #2 | #3 | #4 |
| 3-methoxy dimethyl | 80 | 79.9 | 79.5 | 67 | 40 | | | | 60 | | | | |
| propanamide | | | | | | | | | | | | | |
| 3-butoxy dimethyl | | | | | | 40 | 40 | 40 | | | | | |
| propanamide | | | | | | | | | | | | | |
| N-butyl pyrrolidone | | | | | 40 | | | | | | | | |
| N-methyl pyrrolidone | | | | | | 40 | | | | 80 | | | 60 |
| Dimethyl formamide | | | | | | | 40 | | | | 80 | | |
| Dimethyl acetamide | | | | | | | | 40 | | | | 80 | |
| Chlorinated | 20 | 20 | 20 | | 20 | 20 | 20 | 20 | | 20 | 20 | 20 | |
| Polyvinylchloride | | | | | | | | | | | | | |
| Polyether Sulfone | | | | 33 | | | | | | | | | |
| Thermoplastic | | | | | | | | | 40 | | | | 40 |
| Polyurethane | | | | | | | | | | | | | |
| Polyvinyl pyrrolidone | | 0.1 | 0.5 | | | | | | | | | | |
| total | 100 | 100 | 100 | 100 | 100 | 100 | 100 | 100 | | 100 | 100 | 100 | |
| Morphology | Sponge | Sponge | Finger | Sponge | Finger | Mixed | Sponge | Sponge | Mixed | Solution | Sponge | Finger | Mixed |
| | | | | | | Sponge | | | Sponge | Gelled | | | Sponge |
| | | | | | | Finger | | | Finger | | | | Finger |

Note the beneficial results obtained when the inventive solvent 3-butoxy dimethyl propanamide is combined with conventional solvents DMF, NMP and DMAC. The mixed solvent system using 3-butoxy dimethyl propenamide and the conventional solvents were not only able to dissolve CPVC resin, but also resulted in sponge morphologies. Table 2 also illustrates the efficacy of the inventive amide solvent with polyether sulfone resin, which also resulted in a sponge morphology.

Each of the documents referred to above is incorporated herein by reference. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

1. A method for manufacturing a polyvinyl chloride (PVC) or chlorinated polyvinyl chloride (CPVC) polymer membrane comprising the steps of,
a) dissolving PVC or CPVC polymer in solvent,
b) casting the dissolved PVC or CPVC polymer onto a substrate, and
c) precipitating the cast PVC or CPVC polymer in a non-solvent bath, wherein the solvent comprises an amide represented by the Formula I: 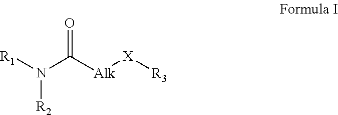
where:
X is O;
R1, R2, R3, and R₄ are independently H, or CₙH₍₂ₙ₊₁₎;
Alk is a CₙH₂ₙ alkylene group, linear or branched; and
n is an integer from 1 to 10.

2. The method of claim 1, wherein the solvent comprises Formula III: 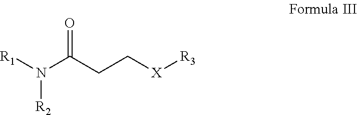
where:
X is O;
R1, R2, R3, and R₄ are independently H, or CₙH₍₂ₙ₊₁₎; and
n is an integer from 1 to 10.

3. (canceled)

4. (canceled)

5. (canceled)

6. (canceled)

7. The method of claim 1, wherein X is O and R3 is CₙH₍₂ₙ₊₁₎.

8. The method of claim 1, wherein the solvent comprises 3-methoxy-N,N-dimethylpropanamide.

9. The method of claim 1, wherein the solvent comprises from 30 to 70 vol % Formula I and/or Formula III, and 30 to 70 vol % of other solvent.

10. The method of claim 8, where the other solvent comprises methyl 5-(dimethylamino)-5-oxopentanoate.

11. The method of claim 8, where the other solvent comprises methyl 5-(dimethylamino)-2-methyl-5-oxopentanoate.

12. (canceled)

13. (canceled)

14. A casting solution for preparing a porous membrane comprising from 10 to 30 wt. % of at least one a polyvinyl chloride (PVC) or chlorinated polyvinyl chloride (CPVC) polymer, and solvent, wherein the solvent comprises Formula I: 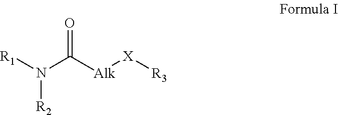
where:
X is O;
R1, R2, R3, and R₄ are independently H, or CₙH₍₂ₙ₊₁₎;
Alk is a CₙH₂ₙ alkylene group, linear or branched; and
n is an integer from 1 to 10.

15. The casting solution of claim 14, wherein the solvent comprises Formula III: 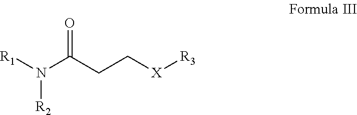
where:
X is O;
R1, R2, R3, and R₄ are independently H, or CₙH₍₂ₙ₊₁₎; and
n is an integer from 1 to 10.

16. (canceled)

17. The casting solution of claim 14, wherein X is O and R3 is CₙH₍₂ₙ₊₁₎.

18. (canceled)

19. (canceled)

20. (canceled)

21. (canceled)

22. (canceled)

23. (canceled)

24. (canceled)

25. A composition comprising a porous membrane cast from the casting solution of claim 14.
